(19) United States
(12) Patent Application Publication
(10) Pub. No.: US 2019/0236487 A1
(43) Pub. Date: Aug. 1, 2019

(54) MACHINE LEARNING HYPERPARAMETER TUNING TOOL

(71) Applicant: Microsoft Technology Licensing, LLC, Redmond, WA (US)

(72) Inventors: Jiapei Huang, Seattle, WA (US); Houdong Hu, Redmond, WA (US); Li Huang, Sammamish, WA (US); Xi Chen, Bellevue, WA (US); Linjun Yang, Sammamish, WA (US)

(73) Assignee: Microsoft Technology Licensing, LLC, Redmond, WA (US)

(21) Appl. No.: 15/883,686

(22) Filed: Jan. 30, 2018

(51) Int. Cl. G06N 99/00

(52) U.S. Cl. CPC G06N 99/005; G06F 3/04842

(57) ABSTRACT

A technique for hyperparameter tuning can be performed via a hyperparameter tuning tool. In the technique, computer-readable values for each of one or more machine learning hyperparameters can be received. Multiple computer-readable hyperparameter value sets can be defined using different combinations of the values. In response to a request to start, an overall hyperparameter tuning operation can be performed via the tool, with the overall operation including a tuning job for each of the hyperparameter sets. A computer-readable comparison of the results of the parameter tuning operations can be generated for the hyperparameter sets, with the comparison indicating effectiveness of the hyperparameter sets, as compared to each other, in the tuning jobs.

### BACKGROUND

Machine learning often involves tuning parameters of computer-readable parametric models using training data. Training data can be operated upon using an initial parametric model, and the results of that operation can be processed to reveal calculated errors in the initial model parameters. The model parameters can be adjusted, or tuned, to reduce the error. More training data can be operated upon using the resulting newly-tuned model, and the results of that operation can be processed to reveal calculated errors in the initial model parameters. The processing of training data using the model and then adjusting the model parameters can be repeated many times in an iterative process to tune a model. For example, such tuning may be done to tune parametric models for identifying features such as visual objects in digital images (such as identifying that an image includes a tree, or that it includes a house) or words in digital audio (speech recognition).

The parameter tuning operations for parametric models in machine learning are governed by parameters other than those in the model being tuned. Such governing parameters are referred to as hyperparameters. In machine learning, such hyperparameters have been selected by administrative users. Such users often utilize a trial-and-error approach, where a user may input some hyperparameters into a computer system, which uses the hyperparameters to govern a model parameter tuning process. A user may then input some different hyperparameter values to find out if those different values result in a better tuning process. Some machine learning frameworks have provided visualizations and other results that allow comparisons between different tuning process jobs, each of which may use different sets of hyperparameter values. For example, a machine learning framework may provide a graph of how precision of a model changed over time for different tuning jobs, with different graph lines for different jobs being overlaid on the same graph for comparison. As another example, a machine learning framework may provide a list of error values for different parameter tuning jobs.

### SUMMARY

The tools and techniques discussed herein relate to a computerized hyperparameter tuning tool, which can provide improved efficiencies for users and computer systems in comparing effectiveness of different sets of hyperparameter values. Also, such efficiencies can allow for a scaled-up tuning process for tuning the hyperparameters that are used in tuning computer-readable parametric models for machine learning. This can facilitate selection of hyperparameter values that are more effective in tuning models in a machine learning process.

In one aspect, the tools and techniques can include performing a technique via a hyperparameter tuning tool. The technique can include receiving computer-readable values for each of one or more hyperparameters that govern operation of a computerized parameter tuning system in tuning parameters in a machine learning operation. The technique can further include defining multiple computer-readable hyperparameter sets that each includes a set of the computer-readable values. The defining of the hyperparameter sets can include using the computer-readable values to generate different combinations of the computer-readable values, with each hyperparameter set including one of the computer-readable values for each of the one or more hyperparameters. The technique can further include receiving a computer-readable request to start an overall hyperparameter tuning operation. The technique can also include responding to that request to start by performing the overall hyperparameter tuning operation via the hyperparameter tuning tool, with the overall hyperparameter tuning operation including a tuning job for each of the hyperparameter sets. Performing the tuning operation can include, for each of the tuning jobs, performing a parameter tuning operation on a set of parameters in a parameter model as governed by the hyperparameter set using the parameter tuning system, with the parameter tuning operation operating on computer-readable training data using the parameter model. Performing the tuning operation can also include, for each of the tuning jobs, generating computer-readable results of the parameter tuning operation for the hyperparameter set, with the results of the parameter tuning operation representing a level of effectiveness of the parameter tuning operation using the hyperparameter set. The technique of FIG. 8 can also include generating a computer-readable comparison of the results of the parameter tuning operations for the hyperparameter sets, with the comparison indicating effectiveness of the hyperparameter sets, as compared to each other.

Another aspect of the tools and techniques can also include performing a technique via a hyperparameter tuning tool. In this technique, computer-readable values can be received for each of one or more hyperparameters that govern operation of a computerized parameter tuning system in tuning parameters in a machine learning operation. Multiple different computer-readable hyperparameter sets can be defined using the hyperparameter values, with each hyperparameter set including a different set of the hyperparameter values, and with each hyperparameter set including one of the hyperparameter values for each of the one or more hyperparameters. The technique can also include generating computer-readable tuning job requests using the hyperparameter sets, with the computer-readable tuning job requests each defining a different one of the hyperparameter sets to govern a parameter tuning job. Each tuning job request can be sent to a to a computerized parameter tuning system, with each tuning job request instructing the parameter tuning system to conduct a parameter tuning job that includes tuning a parameter model as governed by a corresponding hyperparameter set defined in the tuning job request. The technique can also include retrieving a comparison of results of the parameter tuning jobs, with the results indicating effectiveness of the different hyperparameter sets in tuning the parameter model. Further, the technique can include presenting a representation of the comparison using a computer output device.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a schematic diagram of a machine learning hyperparameter tuning system.

FIG. 3 is a schematic diagram of operations and communications in a hyperparameter tuning system.

FIG. 4 is a schematic diagram of start requests, job requests, and components in a hyperparameter tuning system.

FIG. 5 is an illustration of a job submission display that can be presented via a hyperparameter tuning tool.

FIG. 6 is an illustration of a running jobs display (which may also list completed jobs and/or jobs that have not yet started running), which can be presented via a hyperparameter tuning tool.

FIG. 7 is an illustration of a visualization display, which may be provided by a parameter tuning application, and may be presented via a hyperparameter tuning tool.

FIG. 8 is a flowchart of a machine learning hyperparameter tuning tool technique.

FIG. 9 is a flowchart of another machine learning hyperparameter tuning tool technique.

### DETAILED DESCRIPTION

Aspects described herein are directed to techniques and tools for tuning hyperparameters for use in governing machine learning processes. Such improvements may result from the use of various techniques and tools separately or in combination.

Such techniques and tools may include a hyperparameter tuning tool, which can automate generation, submission, and/or monitoring of multiple different parametric model tuning operations, or jobs, each of which can have a different hyperparameter set, with the hyperparameter sets including different combinations of input hyperparameter values. The tool can also facilitate the retrieval and display of results of those tuning operations, as well as comparisons of the results of the different tuning operations with different sets of hyperparameter values.

The tuning operations may be performed in a computer cluster, such as a graphics processing unit (GPU) cluster, and the tuning tool can be configured to work with multiple different parameter tuning applications, such as instances of multiple different types of deep learning frameworks. The parametric models being tuned may be artificial neural networks, such as deep neural networks. The tuning tool may handle training job failures (i.e., failures of the tuning jobs for the different hyperparameter sets) by monitoring job status and re-trying failed jobs automatically.

Various hyperparameters and values may be chosen using the hyperparameter tuning tool. After a user input request (such as clicking a “Submit” button following the input of hyperparameter values to be used), the tool can submit and monitor jobs with combinations of the hyperparameter values (such as with a different job for each different possible combination of the entered hyperparameter values, with each combination being used as a hyperparameter set).

The hyperparameter tuning tool may also facilitate comparison of results of jobs using the different hyperparameter sets. For example, the tool may receive a request to retrieve comparisons of selected hyperparameter sets, such as a user input request to visualize results of jobs. This may yield training curves that illustrate how effectiveness of the parameter models being trained compares between different hyperparameter value sets. As an example, this may yield a displayed graph of overlaid training curves (such as training curves showing the change in precision over time) for selected jobs, along with listings of error values for the jobs using the different hyperparameter sets.

Additionally, the tool may monitor the tuning jobs and can automatically retry jobs that fail. The tool may also provide notifications, such as by email, when the status of jobs change.

Accordingly, one or more substantial benefits can be realized from the tools and techniques described herein using the hyperparameter tuning tool. For example, the use of the tuning tool to define hyperparameter sets from input values, and to generate job requests and submit those job requests can provide several benefits. For example, such use of the tuning tool can also allow for more combinations of hyperparameters to be tested, and for the results of such combinations to be compared. Additionally, because a user need not manually enter each hyperparameter value combination, the tuning tool can reduce typographical errors in the entering of the hyperparameter values, thereby increasing the reliability of selecting hyperparameter value combinations that are most effective. These benefits can be further improved by the automatic retrying of failed tuning jobs, and facilitating comparison of tuning results. Accordingly, the hyperparameter tuning tool can result in better hyperparameter value selection that can yield better parameter model tuning, and overall better machine learning results, with a simplified interface and less time and effort by computer users who oversee the machine learning operations, such as deep neural network model training processes.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

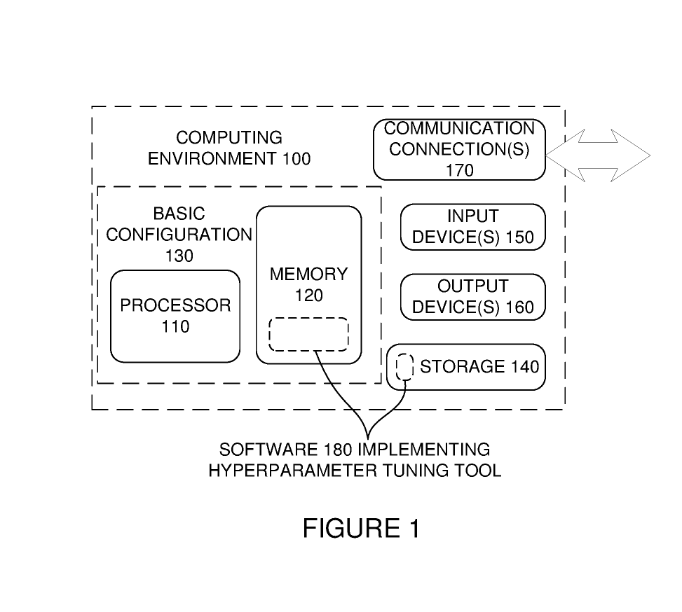

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment (100) in which one or more of the described aspects may be implemented. For example, one or more such computing environments can be used as a client system, tool server system, and/or a computer in a computer cluster. Generally, various computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment (100) includes at least one processing unit or processor (110) and memory (120). In FIG. 1, this most basic configuration (130) is included within a dashed line. The processing unit (110), such as a central processing unit and/or graphics processing unit, executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing hyperparameter tuning tools. An implementation of a hyperparameter tuning tool may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The memory (120) can include storage (140) (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing entity. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “perform,” “choose,” “adjust,” “define”, “generate”, and “operate” to describe computer operations in a computing environment. These and other similar terms are high-level descriptions for operations performed by a computer, and should not be confused with acts performed by a human being, unless performance of an act by a human being (such as a “user”) is explicitly noted. The actual computer operations corresponding to these terms vary depending on the implementation.

### II. Machine Learning Hyperparameter Tuning System

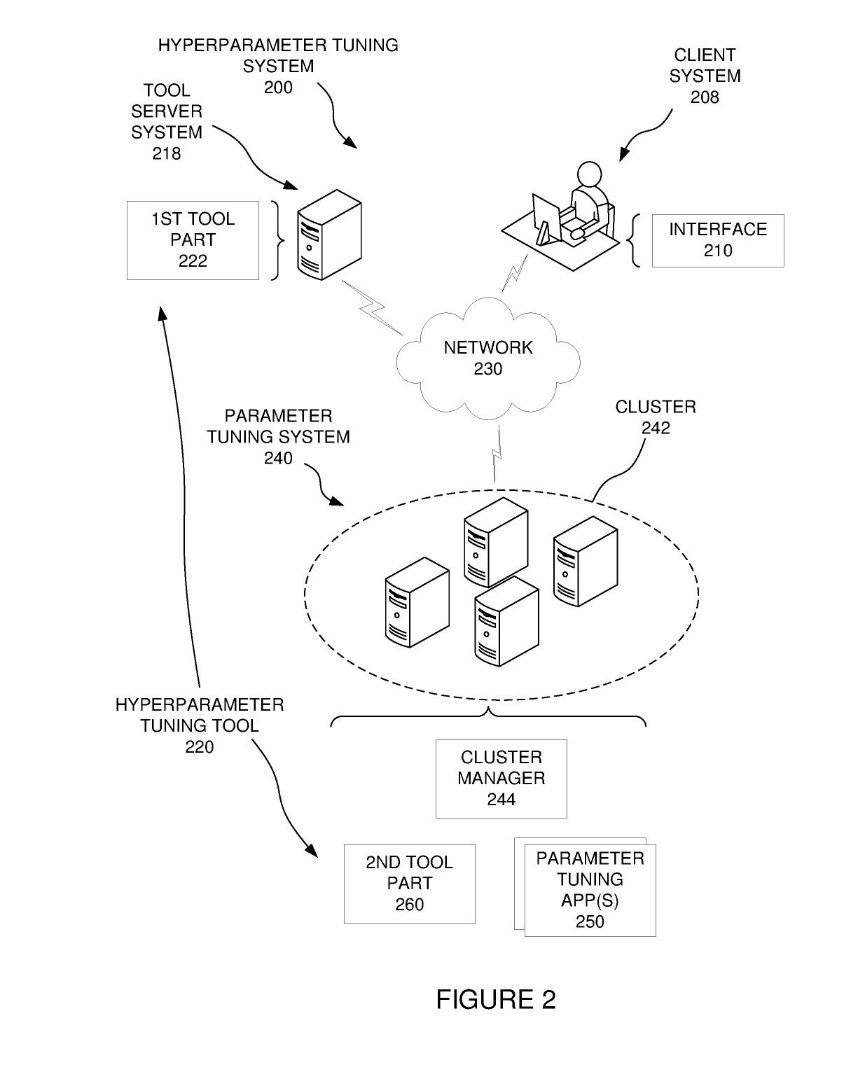

FIG. 2 is a schematic diagram of a machine learning hyperparameter tuning system (200) in conjunction with which one or more of the described aspects may be implemented.

Referring still to FIG. 2, components of the hyperparameter tuning system (200) will be discussed. Each of the components of FIGS. 1-4 includes hardware, and may also include software. For example, a component of FIG. 2 can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices and other operations of the component being performed on one or more machines of a server).

A. Example Cluster-Based Hyperparameter Tuning System

Referring now to FIG. 2, an example of a hyperparameter tuning system (200) will be discussed. The hyperparameter tuning system (200) can include a client system (208), which can host an interface (210), through which a user can input data, and to which results can be presented to a user. For example, the client system (208) may be a laptop or desktop computer, or a mobile device such as a smartphone or tablet computer. The hyperparameter tuning system can also include a tool server system (218). A hyperparameter tuning tool (220) can include a first tool part (222) running on the tool server system (218). The tool server system (218) can communicate with one or more client systems such as the client system (208) through a computer network (230). A parameter tuning system (240) can also communicate with the tool server system (218) through the network (230).

The parameter tuning system (240) can be configured to perform machine learning operations, such as tuning parameters of machine learning models. As an example, the parameter tuning system (240) can include a computer cluster (242), which may be a combination of multiple sub-clusters configured to operate together. The cluster (242) can be managed by a cluster manager (244), which can be running in the cluster (242). For example, the cluster manager (244) can distribute and monitor jobs being performed by one or more processors in the cluster (242). In one example, the cluster may include graphics processing units that operate together as dictated by the cluster manager (244) to execute jobs submitted to the cluster (242). The cluster (242) can run one or more parameter tuning applications (250), such as operating instances of deep learning frameworks. The cluster (242) can also run a second tool part (260) of the hyperparameter tuning tool (220). The second tool part (260) can act as an intermediary between the first tool part (222) in the tool server system (218) and the parameter tuning application(s) (250) in the cluster (242). As an example, the first tool part (222) may be implemented as a Web-based application that utilizes programming such as computer script in one or more scripting languages to perform actions discussed herein. Additionally, the second tool part (260) may be a script running in the computer cluster (242). The interface (210) can utilize a Web browser application to interface with the first tool part (222). The first tool part (222) and the second tool part (260) can communicate requests to each other, and can be programmed to process such requests and provide responses over the network (230), which can be facilitated by the cluster manager (244).

The second tool part (260) can communicate with the parameter tuning application(s) (250) using application programming interfaces that are exposed by the parameter tuning application(s) (250). Different parameter tuning applications (250) can dictate the use of different application programming interface calls and responses. Accordingly, if the second tool part (260) is to interact with multiple different parameter tuning applications (250), the second tool part can include alternative programming code for translating requests and responses differently for different parameter tuning applications (250). For example, the second tool part (260) can include multiple scripts running in the cluster manager (244), with one script for handling requests and responses for each different parameter tuning application (250). In this instance, the communications sent from the first tool part (222) to the second tool part (260) can be addressed to a specified script in the second tool part (260). For example, the first tool part (222) may send a parameter tuning job request to a specified script in the second tool part (260), to be forwarded to a specified parameter tuning application (250). That script can be programmed in a scripting language to respond to the request by generating one or more application programming interface calls that are formatted for the corresponding parameter tuning application, and sending those application programming interface calls as a job request to the parameter tuning application (250).

A hyperparameter tuning system may be configured in various alternative ways that are different from what is illustrated in FIG. 2 and discussed above. For example, the hyperparameter tuning tool (220) may be incorporated into the parameter tuning application (250), rather than being separate from the parameter tuning application (250). If the hyperparameter tuning tool (220) is incorporated into the parameter tuning application (250), communications discussed herein between the hyperparameter tuning tool and the parameter tuning application may be calls within the parameter tuning application (250). As another example, the hyperparameter tuning tool (220) could be implemented as a single part running within a cluster (242) where the parameter tuning application (250) is running, or entirely outside that cluster (242). Also, the hyperparameter tuning tool (220) may be implemented in a different system, such as where the components of the hyperparameter tuning system (200) are all hosted on a single computing machine, so long as that machine has sufficient capacity to perform the parameter tuning operations discussed herein.

B. Hyperparameter Tuning System Communications and Operations

Additional details of communications and operations of components in a hyperparameter tuning system will now be discussed. In the discussion of embodiments herein, communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks.

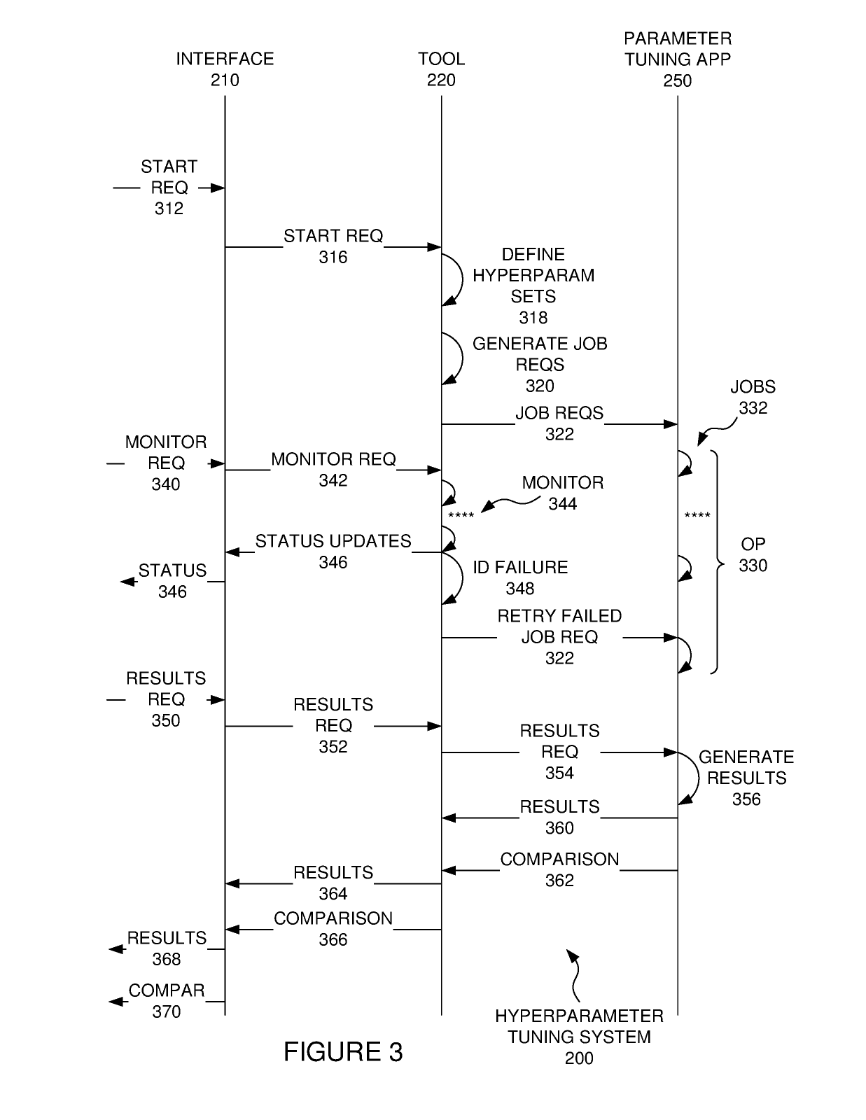

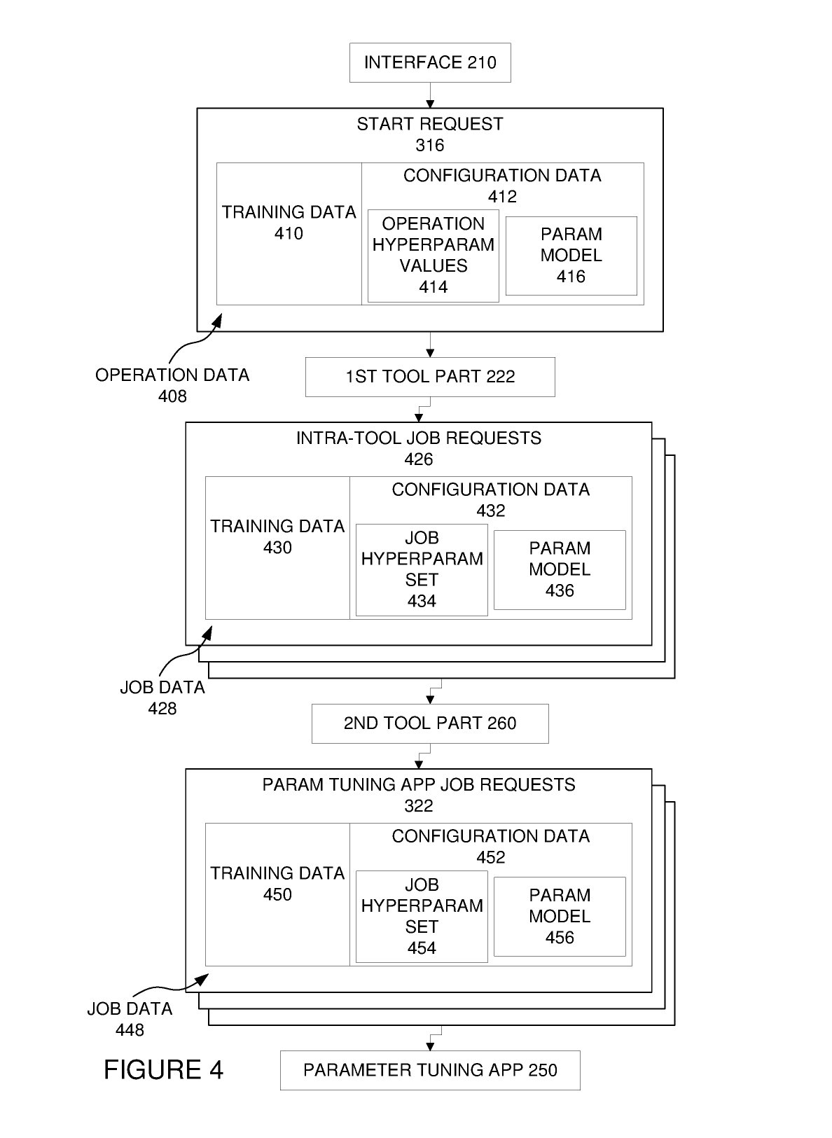

Referring now to FIG. 3, communications and operations discussed with reference to FIG. 3 may be performed in the hyperparameter tuning system (200) of FIG. 2 discussed above, or in some other system that includes a hyperparameter tuning system (200), with an interface (210), a hyperparameter tuning tool (220), and a parameter tuning application (250), as discussed herein. As discussed above, the tuning tool (220) may be a single unified computer component, or it may be split into multiple parts. Also, the communications and operations of FIG. 3 may be performed in different orders than discussed herein. Also, fewer or more communications and operations than those discussed herein may be used. For example, communications illustrated as a single communication may be combined with each other, or may be split into multiple sub-communications, such as multiple sub-commands or sub-messages. Similarly, operations discussed herein may be combined or split into multiple sub-operations. With such alternatives in mind, some examples are now discussed with reference to FIGS. 3 and 4.

Referring to FIG. 3, the interface (210) can receive a start request (312) for a hyperparameter tuning operation, such as from a user input action. The start request (312) can include user-specified data, which can be used in performing a hyperparameter tuning operation. In response to receiving the start request (312), the interface (210) can send a start request (316) to the hyperparameter tuning tool (220). In one example embodiment illustrated in FIG. 4, the start request (316) can be sent to a first tool part (222). The start request (316) can include operation data (408) to be used in the hyperparameter training operation. For example, the operation data (408) can include training data (410), such as digital audio data if the machine learning is for speech recognition models, or digital image data if the machine learning is for visual image recognition models. The operation data (408) can also include configuration data (412), which can dictate how the training data (410) is to be processed. For example, the configuration data (412) can include the operation hyperparameter values (414) to be used in governing the parameter tuning jobs of the hyperparameter tuning process. The configuration data (412) can also include a parameter model (416) to be tuned in the parameter tuning jobs of the hyperparameter tuning process. For example, the model may be a speech recognition model, an image recognition model, or some other model used in a machine learning process. As an example, a parameter model (416) may be an artificial neural network, such as a deep neural network.

Referring to FIGS. 3 and 4, in response to receiving the start request (316), the tool (220) can define (318) hyperparameter sets from the received values (414) in the operation data (408). The tool (220) can also generate (320) job requests to be sent to the parameter tuning application (250). In one example illustrated in FIG. 4, the first tool part (222) of FIG. 2 can receive the start request (316) and respond by generating intra-tool job requests (426). Each intra-tool job request (426) can include job data (428), which can include training data (430) and configuration data (432) for a parameter tuning job. The configuration data (432) can include a job hyperparameter set (434), which can be defined (318) by the first tool part (222) by generating combinations of hyperparameter values from the received operation hyperparameter values (414). For example, the first tool part (222) can identify each hyperparameter value (414) for each hyperparameter, and can define hyperparameter sets that include that value. As an example, a technique for this defining of hyperparameter sets can include nested loop functions, with one loop for each hyperparameter that has a hyperparameter value (414). Each time the inner loop executes, it can store the current hyperparameter values as a hyperparameter set. Also, after each execution of each loop, the hyperparameter value for that loop can move to the next entered value for the corresponding hyperparameter. This can continue for each loop until it has performed a loop for all the available values for that hyperparameter. Once all loops are complete for the outer-most loop in the nested loops, the hyperparameter set definition can complete. Alternatively, other different techniques may be used for defining the hyperparameter sets (434).

The configuration data (432) in an intra-tool job request (426) can also include a parameter model (436) to be tuned in the requested parameter tuning job. The first tool part (222) can generate the intra-tool job requests (426), with one job request for each of the defined hyperparameter sets. This generating can include inserting the job data (428) in the request, in a format that the second tool part (260) is programmed to understand. The intra-tool job requests (426) can be sent from the first tool part (222) to the second tool part (260). The second tool part (260) may simply translate each intra-tool job request (426) into a format that can be recognized and processed by the parameter tuning application (250), such as into the form of application programming interface calls that are exposed and published for the parameter tuning application (250). For example, this may be done by mapping the items of job data (428) in the intra-tool job requests (426) onto corresponding items of parameter tuning application job requests (322). This translating can generate a parameter tuning application job request (322) for each intra-tool job request (426). The parameter tuning application job requests (322) can be formatted to be understood by the selected parameter tuning application (250), such as by complying with available application programming interface call requirements for the parameter tuning application (250).

Each parameter tuning application job request (322) can include job data (448), which can include training data (450) and configuration data (452). The configuration data (452) can include a job hyperparameter set (454) and a parameter model (456) for the corresponding parameter tuning job. The second tool part (260) can send each parameter tuning application job request (322) to the parameter tuning application (250), requesting the parameter tuning application (250) to perform the requested jobs.

Referring to FIG. 3, in response to the job requests (322), the parameter tuning application (250) can perform the overall hyperparameter tuning operation (330), which can include running a job (332) for each of the received parameter tuning application job requests (322). The jobs (332) can be performed in parallel with each other, such as where they are performed in parallel in a computer cluster that hosts the parameter tuning application (250). Alternatively, the jobs (332) may be performed in series. The performance of each job (332) can include tuning the provided parameter model, as governed by the provided hyperparameter set for the job (332). This can be done using the machine learning process of tuning model parameters that is typically performed by the parameter tuning application (250). For example, this can include operating on training data using the provided model, and changing the parameter values of the model to reduce error values in the model that are revealed by the training process. This tuning process can include an iterative process of processing training data with the model, changing the model parameter values to reduce errors, processing more training data, again changing the model parameter values to reduce errors, and continuing until completion of the specified tuning process. During the processing of the jobs (332), the parameter tuning application (250) can generate results for the job. For example, the results may include error values, and may also include precision values that change over time as changes are made to parameter values of the model being tuned.

Referring still to FIG. 3, the interface (210) can receive a monitor request (340), which can request to monitor the status of one or more of the jobs (332). This request and other requests received by the interface (210) may be from user input actions, with one action triggering a corresponding request. Alternatively, at least some of the requests may result from a combination of multiple user interface actions. The interface (210) can forward the monitoring request (342) to the tool (220), which can monitor (344) the jobs (332). For example, the monitoring (344) may include the tool (220) periodically sending status requests to a component that is managing the jobs (332), such as the cluster manager (244) of FIG. 2, if the parameter tuning application (250) is running the jobs (332) in a managed cluster (242). Alternatively, the tool (220) may send such status requests to the parameter tuning application (250) in some embodiments. The tool (220) can receive status indicators in response to the status requests. For example, a status indicator may indicate that the job is not yet started, that it is running (and if so, how much progress has been made), that it has failed (and if so, how much progress was made before the failure), or that it has successfully completed.

If the tool (220) receives an indication that a job's status has changed (e.g., from running to successful completion), the tool (220) can respond by sending a status update (346) to the interface (210). In some implementations, the status updates (346) may be in the form of emails that are sent from the tool (220) to a registered email address corresponding to the submitted jobs (332) (e.g., a user profile corresponding to a logged-in user profile that submitted the start request (312)). In response to receiving a status update (346), the interface (210) can present the status (346), such as by displaying an email that indicates the status update.

If the tool (220) identifies (348) failure of a job (332), such as by receiving an indication that the job's status has changed from running to failed, then the tool (220) can respond by sending a retry failed job request (322). This request can be the same as, or at least similar to, the original job request (322) sent for the failed job (332). In response to receiving the retry failed job request (322), the parameter tuning application (250) can retry performing the job (332). In some embodiments, the tool (220) may only send a retry failed job request (322) if the failed job (332) made at least some progress prior to its failure, or only if at least some progress has been made in at least some of the jobs (332) in the overall operation (330). For example, this can be determined from information that the tool (220) retrieves from the parameter tuning application (250), or from some other component, such as the cluster manager (244) (which may report data such as progress values for jobs, as discussed below).

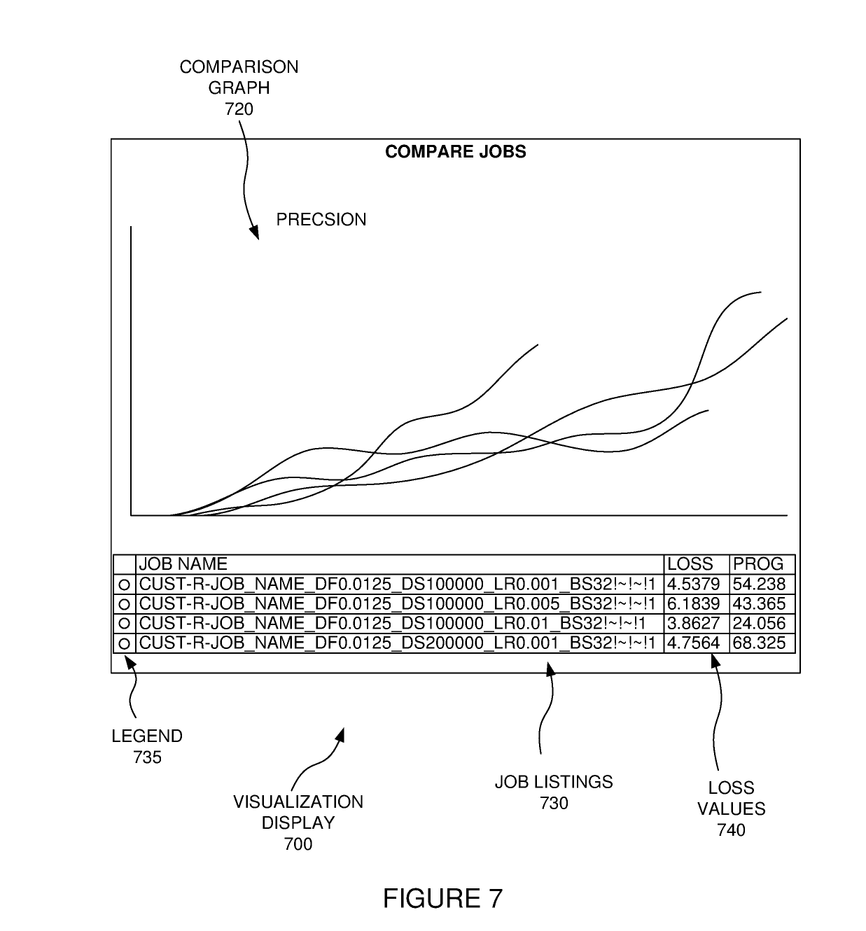

Referring still to FIG. 3, after the jobs (332) have started running, the tool (220) can retrieve results for the jobs (332), and comparisons of results between different jobs (332) in the overall operation (330). This may be done while the jobs (332) are running and/or after the jobs (332) are completed. Specifically, the interface (210) can receive a results request (350), such as a request to visualize results of a job (332) or a set of multiple jobs (332). In response, the interface (210) can send a results request (352) to the hyperparameter tuning tool (220). The tool (220) can respond by sending a results request (354) to the parameter tuning application (250), such as in an application programming interface call sent from a second part of the tool (220) running in a cluster with the parameter tuning application (250). The parameter tuning application (250) can respond by retrieving results (356), and possibly by generating a comparison of the results. For example, the parameter tuning application (250) may render a visualization that includes results and comparisons of results, such as the graph and table illustrated in FIG. 7 discussed below. Alternatively, the parameter tuning application (250) may provide the results to the tool (220), and the tool (220) may process the results to construct and render a visualization of results and comparisons.

The parameter tuning application (250) can return the results (360) and comparison (362) to the tool (220), and the tool (220) can forward results (364) and a comparison (366) to the interface, which can present the results (368) and the comparison (370) to a user, such as on a computer display. In one implementation, where the results and comparison are rendered by the parameter tuning application (250), the parameter tuning application (250) may store a rendered page (such as a Web page) in a location, and provide an address, such as a uniform resource locator, to allow the interface (210) to retrieve the rendered page.

C. Hyperparameter Tuning System User Interface Examples

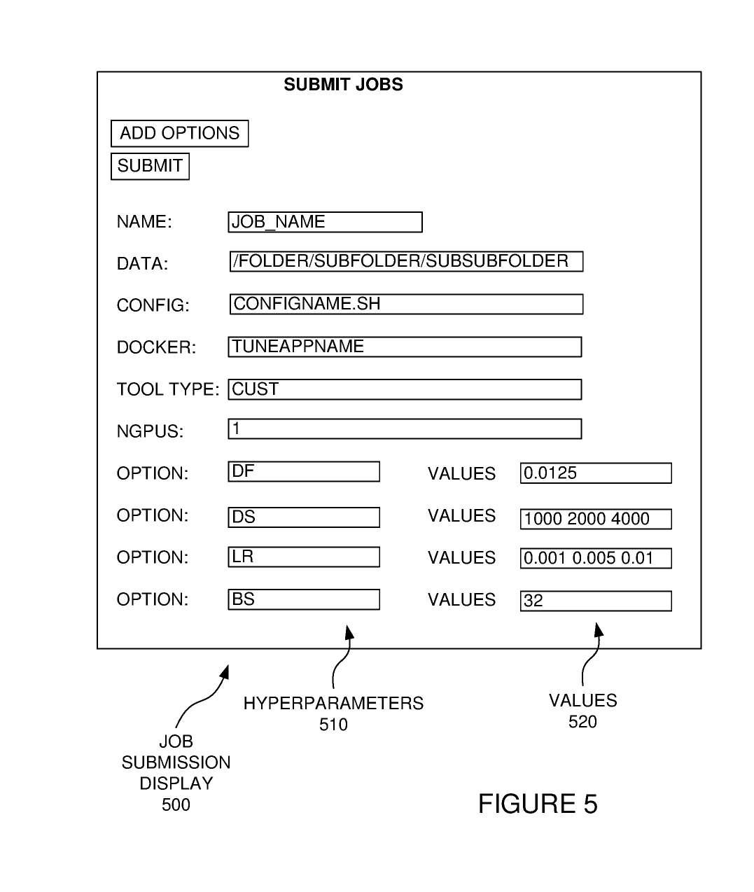

Examples of user interface displays for use with the hyperparameter tuning tool will now be discussed with reference to FIGS. 5-7.

1. Job Submission Display

FIG. 5 illustrates an example of a job submission display (500) that can be displayed to a user on a computer display to receive user input specifying data to be used for a hyperparameter tuning operation. The job submission display (500) can be provided by the hyperparameter tuning tool via an interface. For example, the job submission display (500) may be a Web page, although another type of display such as an application dialog may be used. The job submission display (500) can include data entry areas for entering values adjacent to identifiers for those values.

In the illustrated example, a value of JOB_NAME is entered adjacent to a NAME identifier for the name of the overall hyperparameter tuning process. A value of /FOLDER/SUBFOLDER/SUBFOLDER is entered adjacent to a DATA identifier for a location, such as a filesystem path to a location for training data to be used in the parameter tuning jobs of the hyperparameter tuning operation. A value of CONFIGNAME.SH is entered adjacent to a CONFIG identifier for the location of a configuration file that can include configuration data for the hyperparameter tuning operation, which can include a model to be tuned by the jobs of the operation as well as other configuration data. A value of TUNEAPPNAME is entered adjacent to the DOCKER identifier for identifying a container for the parameter tuning application to be used in the overall tuning application, such as a container for the parameter tuning application in a computer cluster. This can be used to select which of multiple available parameter tuning applications is to be used for the hyperparameter tuning process, and the hyperparameter tuning tool can direct its communications to that application and format its communications for the application. For example, a different second tool part can be used for each different type of parameter tuning application. Thus, each second tool part can be configured to communicate with a different type of hyperparameter tuning application, such as using different application programming interface calls for each application.

Referring still to FIG. 5, a value of CUST can be entered adjacent to the TOOL TYPE identifier, indicating a tool type with which to run the Docker container. The tool type may indicate an internal toolkit, or it may indicate that a custom toolkit is to be used. In the example, the value of CUST indicates a custom toolkit is to be used, and a custom docker image is used to support the toolkit, such as an open source toolkit. A value of one can be entered adjacent to the NGPUS (number of graphics processing units) identifier, indicating that one graphics processing unit is to be used for each parameter tuning job. Other values may also be entered, such as an entry for indicating whether only one process is allowed for a software container, specifying a computer server rack to be used in the processing, and/or specifying a previous model (if multiple rounds of training are used for a single model, this value could indicate a previously-tuned model to be used in the current tuning process). These other values as well as the values for NAME, DATA, CONFIG, DOCKER, TOOL TYPE, and NGPUS can be the same for all the parameter tuning jobs in the overall hyperparameter tuning operation.

The job submission display 500 can also specify hyperparameters (510) and values (520) entered adjacent the indicators for the corresponding hyperparameters (510). User input can be provided for each hyperparameter (510), to enter a single value or multiple values. In this example, the multiple values for a hyperparameter are separated by a space within the text entry box. The tool can be configured to parse such data and identify the values within each box. The hyperparameters (510) are indicated by the “OPTION” text, and additional text entry boxes for options (additional hyperparameters (510)) can be provided in response to user input selecting the ADD OPTIONS button at the top of the job submission display (500). In the illustrated example, there are values entered for four hyperparameters. One is DF, which can be decay factor (which could be specified as “decay_factor”, rather than DF); another is DS, which can be decay steps (which could be specified as “decay_steps”, rather than DS); another is LR, which can be an initial learning rate; and another is BS, which can be batch size.

The initial learning rate (LR) is the initial fraction of the learning error that is corrected for the parameters in a model being tuned in a machine learning process. For example, the learning rate may be used with backpropagation in tuning parameter models that are artificial neural networks, where backpropagation is a technique that can be used to calculate an error contribution of each neuron in an artificial neural network after a batch of training data is processed. Typically, only a fraction of this calculated error contribution is corrected when tuning the artificial neural network model, and the initial fraction to be taken out is learning rate hyperparameter.

The number of items in a batch of training data (such as the number of images for image recognition) is dictated by the batch size (BS) hyperparameter. The decay steps (DS) hyperparameter is the number of steps (processed training data batches) between dropping the value of the learning rate, and the decay factor (DF) is the ratio indicating how much the learning rate is dropped after the number of steps in the decay steps hyperparameter. These are merely examples of hyperparameters that can be tuned using the hyperparameter tuning tool. Values of other hyperparameters may be entered and tuned in addition to, or instead of, these hyperparameters.

In the example, a single value of 0.0125 is entered for the decay factor (DF), values of 1000, 2000, and 4000 are entered for the decay steps (DS), values of 0.001, 0.005, and 0.01 are entered for the initial learning rate (LR), and a single value of 32 is entered for the batch size (BS). A user input start request can be provided for the hyperparameter tuning process indicated in the job submission display (500) by selecting the SUBMIT button on the job submission display (500). The hyperparameter tuning tool can respond to that start request by defining hyperparameter sets for corresponding jobs, generating the requests for the corresponding jobs, and sending the job requests to the parameter tuning application indicated on the job submission display.

2. Running Jobs Display

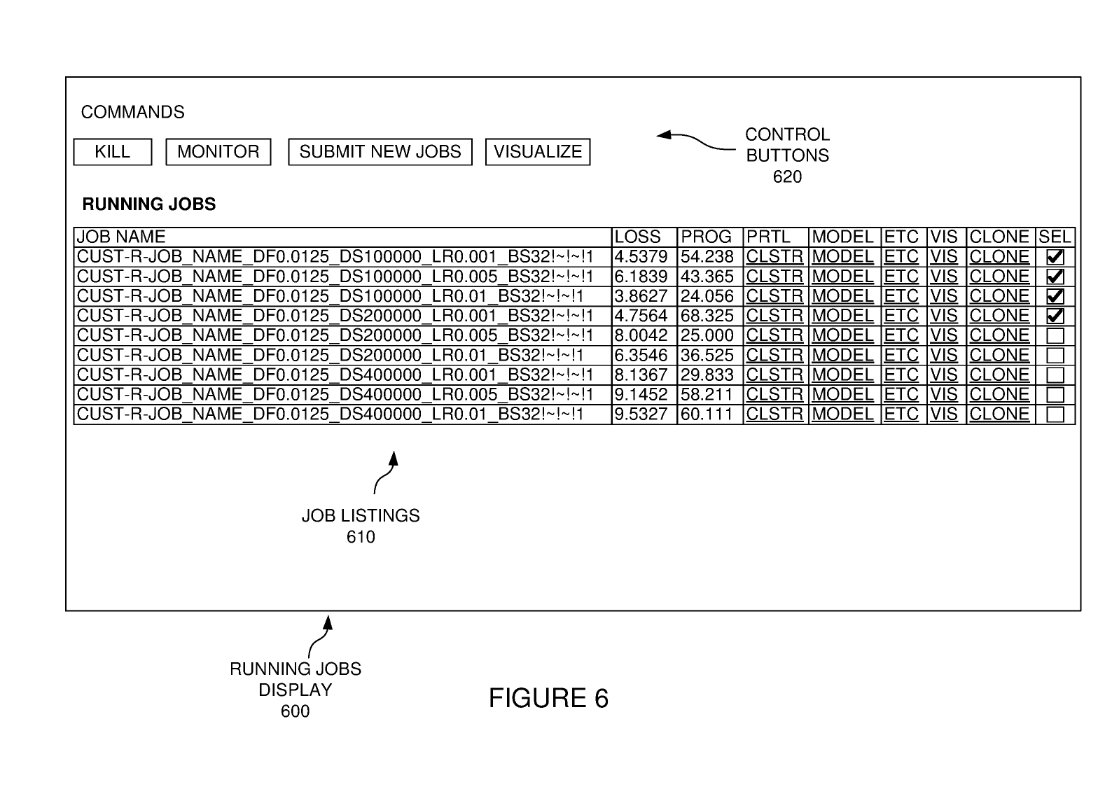

Referring now to FIG. 6, a running jobs display (600) will be discussed. The running jobs display (600) can be displayed after jobs have been submitted to run, and may continue to be displayed after the jobs are complete. The running jobs display can include job listings (610). For example, each job listing (610) can be a row in a table that applies to, or corresponds to, a job that is running. The table can include a job name column that can list the job names for the corresponding jobs. Each job name can include the general name for the operation to which the job belongs, as indicated in the job submission display. Also, each job name can include an indication of hyperparameters that have been entered on the job submission display (500) for the overall hyperparameter tuning process that includes that job, as well as the hyperparameter values in the hyperparameter set that is governing that job. For example, in FIG. 6, the top job name is as follows:

CUST-R-JOB_NAME_DF0.0125_DS100000_LR0.001_BS32!˜!˜!1

This name indicates that the hyperparameter set for this job includes a decay factor (DF) value of 0.0125, a decay steps (DS) value of 100000, an initial learning rate (LR) value of 0.001, and a batch size (BS) of 32. As can be seen by the hyperparameter values in the job names the hyperparameter tuning tool has defined a hyperparameter set for each combination of the hyperparameter values entered by user input through the job submission display (500), and has submitted a parameter tuning job for each of them. Accordingly, rather than having a user manually enter and re-enter values for each of these possible hyperparameter sets, a user can simply enter each hyperparameter value one time in the job submission display, and request the hyperparameter tuning tool to define the hyperparameter sets from combinations of those values, and submit the corresponding parameter tuning jobs to the parameter tuning application. This can save substantial time and effort on the part of computer users, and can speed up the process of defining and submitting the jobs.

Still referring to FIG. 6, the job listings (610) can each include an entry in a loss column, which can include a loss value for the corresponding parameter tuning job. The loss values can be retrieved from the parameter tuning application, such as in response to requests for status updates or results requests from the hyperparameter tuning tool. A lower loss value typically indicates a more accurate model in the tuning process, and thus for the same model and training data, a lower loss can indicate a comparatively more effective set of hyperparameters. However, other factors may also be considered in deciding which hyperparameter set is most effective, such as the learning curve that measures precision, as discussed below with reference to FIG. 7. The values herein for losses and progress, as well as the precision learning curves illustrated in FIG. 7, are not actual values from a tuning process, but are included in the figures and discussed herein for convenience in explaining the hyperparameter tuning tool and the over hyperparameter tuning system and techniques. Accordingly, the loss values, progress values, and precision learning curves of the figures may not correlate with each other as they would in actual tuning results.

Each job listing (610) can also include an entry in a progress column (PROG), which can indicate how much progress has been made in running the model, with higher numbers indicating more progress. The job listings (610) can also each include an entry in a portal (PRTL) column, which can be a link to a portal for a computer system running the parameter tuning application, such as a link to a Web portal for a cluster that is running the parameter tuning application. Additionally, the job listings (610) can include an entry in the model column, which can be a link to a location of the parameter model used in the corresponding parameter tuning job. Also, the “ETC” column entry for each job listing (610) can include a link to a storage location that includes related stored resources for the corresponding job.

Also, each job listing (610) can include an entry in the visualization (VIS) column that can be a link to be selected to retrieve and display a visualization for that job, such as a page that displays results for that job, such as a listing of the loss for the job, and a precision learning curve for the job. Each job listing (610) can also include a listing in the clone column, which can be a link that can be selected to generate entries in the job submission display that are the same as for that job. For example, these may include all the values other than the option values in the job submission display (500) discussed above, and they may even include pre-populated values (the same values as in the job) for the options (hyperparameter values such as DF, DS, LR, and BS in FIG. 5. With such values prepopulated from the base job whose job listing clone link was selected, user input can be provided to select whatever different values are to be used in a subsequent hyperparameter tuning operation, without needing to re-enter all the values manually for the new operation.

In addition, each job listing (610) can include a checkbox in the selection (SEL) column, which can be checked with user input to select that job for actions to be selected from control buttons (620) on the running jobs display (600). For example, user input selecting one or more job listings (610) and selecting the button labeled KILL can request that the tool terminate the selected jobs, with the tool responding by sending requests to the parameter tuning application to terminate those jobs. Selecting the MONITOR button while job listings (610) are selected can generate and send monitor requests (342) discussed above with reference to FIG. 3, requesting that the tool monitor the status of the jobs corresponding to the selected job listings (610). This can result in the tool providing status updates (346) in response to job status changes and in retrying selected jobs that have failed. Selecting the SUBMIT NEW JOBS button can bring up the job submission display (500), illustrated in FIG. 5 and discussed above, such as with the text entry boxes being blank, rather than being pre-populated as with the job cloning feature discussed above.

3. Visualization Display

If job listings (610) are selected and the VISUALIZE button is selected, a results request (352) can be sent to the tool (see FIG. 3), requesting a visualization of job results and comparison between job results for the jobs represented by the selected job listings (610). The tool can respond as discussed above with reference to FIG. 3. This can result in the interface presenting results (360) and results comparisons (370). An example of this is illustrated in a visualization display (700) of FIG. 7, which displays results and comparisons of the results for the job listings (610) that are selected in the running jobs display (600) of FIG. 6. The visualization display (700) can include a comparison graph (720) and job listings (730). The comparison graph (720) can be a graphical visual comparison of the precision results, in the form of a line graph with learning curves representing precision values at different times during the running of the selected jobs, with the learning curves for each of the selected jobs being overlaid on a single graph. While not illustrated in FIG. 7, each curve may have a different color, and a legend (735) for the comparison graph (720), with the legend indicating which color corresponds to which job listing (730). For example, the legend (735) can be included as a column in the job listings (730), with each job listing (730) including an entry in the legend that is an area (such as a circle or some other shape) that is the same color as the learning curve in the comparison graph (720) corresponding to that job listing (730).

The job listings (730) can also include loss values (740) for the selected jobs, with those loss values also being results that can indicate effectiveness of the corresponding hyperparameter sets of the jobs. Accordingly, the table of job listings can be a textual (rather than graphical) comparison of the effectiveness of the different jobs and corresponding hyperparameter sets. For example, a lower loss rate can indicate a more effective hyperparameter set, and a higher loss rate can indicate a less effective hyperparameter set. Contrarywise, greater increase in the precision values illustrated in the precision learning curve of the comparison graph (i.e., a curve that has a greater upward trend) can indicate a more effective corresponding parameter set, and less of an increase in the precision values illustrated in the precision curve of the comparison graph can indicate a less effective corresponding parameter set.

The visualization display (700) may be presented while the corresponding jobs are still running and/or after the corresponding jobs are complete. Using the results and comparisons of results, a hyperparameter set can be selected, such as a hyperparameter set in a job that exhibits the lowest loss and/or the greatest precision gain during the tuning. This selection may be received as user input after the results comparisons are presented, or it may be provided as an automated identification and selection. For example, the hyperparameter set with the lowest loss may be identified and selected by the hyperparameter tuning system for use in subsequently tuning parameter models. This identification and selection can include analyzing the loss values in the results. As an alternative, a hyperparameter set with the greatest gain in precision may be identified and selected by the hyperparameter tuning system by analyzing the precision learning curves, or directly analyzing values for precision from the job results. Other alternative selection criteria may be used, such as a weighted combination that factors in the loss values and the gain in precision, to provide a computer-readable score for each job, which can then be compared between jobs to identify and select a best scoring job and corresponding hyperparameter set.

The selected hyperparameter set can be used in subsequent tuning operations for tuning parameter models. For example, a hyperparameter set may be used in tuning general speech recognition models, user-specific speech recognition models, image recognition models, or other machine learning models. Using the hyperparameter tuning model discussed herein can allow better tuning of the hyperparameters, which can in turn produce better parameter model tuning. Indeed, the use of such hyperparameters selected using a hyperparameter tool as discussed herein has been shown to improve the accuracy of image classification. Specifically, a hyperparameter selection tool was used to tune over 100 models used in the image classification, with different hyperparameter sets selected using the hyperparameter tuning tool. The image classification accuracy of the models tuned with the hyperparameters tuned using a parameter selection tool as discussed herein was greater than with previous models tuned with different hyperparameters that were not tuned with the hyperparameter tuning tool.

### III. Hyperparameter Tuning Tool Techniques

Several hyperparameter tuning tool techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic. Additionally, the different features of the techniques discussed below may be used with each other in different combinations, as the different features can provide benefits when used alone and/or in combination with other features.

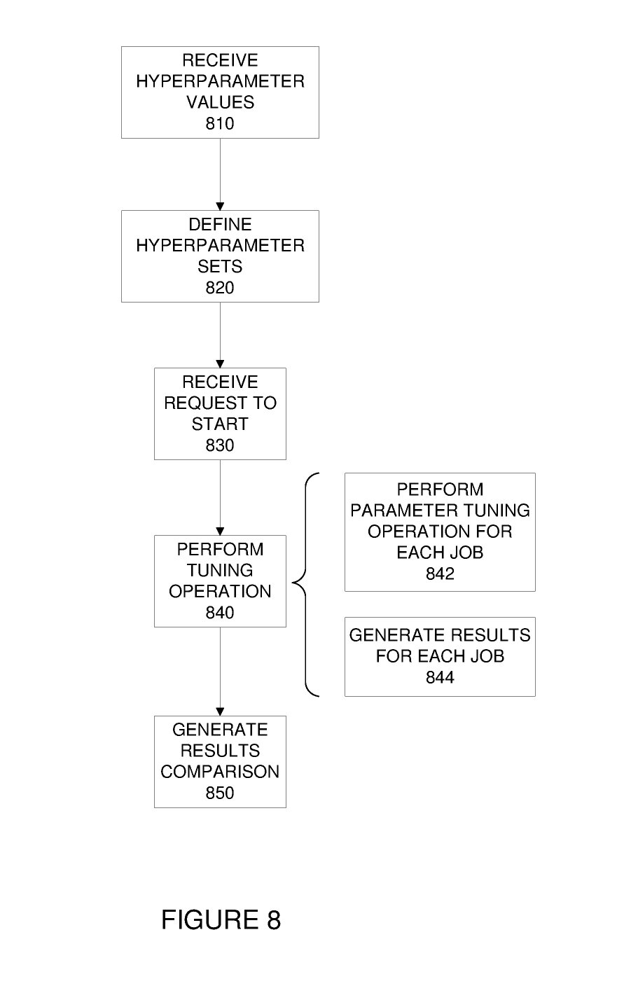

Referring to FIG. 8, a hyperparameter tuning tool technique will be discussed. Each of the acts illustrated by a corresponding box in FIG. 8 can be performed via a hyperparameter tuning tool, as discussed above. The technique can include receiving (810) computer-readable values for each of one or more hyperparameters that govern operation of a computerized parameter tuning system in tuning parameters in a machine learning operation. The technique can further include defining (820) multiple computer-readable hyperparameter sets that each includes a set of the computer-readable values. The defining (820) of the hyperparameter sets can include using the computer-readable values to generate different combinations of the computer-readable values, with each hyperparameter set including one of the computer-readable values for each of the one or more hyperparameters. The technique can further include receiving (830) a computer-readable request to start an overall hyperparameter tuning operation. The technique can also include responding to that request to start by performing the overall hyperparameter tuning operation via the hyperparameter tuning tool (such as doing so, as discussed above with reference to FIG. 3), with the overall hyperparameter tuning operation including a tuning job for each of the hyperparameter sets. Performing (840) the tuning operation can include, for each of the tuning jobs, performing (842) a parameter tuning operation on a set of parameters in a parameter model as governed by the hyperparameter set using the parameter tuning system, with the parameter tuning operation operating on computer-readable training data using the parameter model. Performing (840) the tuning operation can also include, for each of the tuning jobs, generating (844) computer-readable results of the parameter tuning operation for the hyperparameter set, with the results of the parameter tuning operation representing a level of effectiveness of the parameter tuning operation using the hyperparameter set. The technique of FIG. 8 can also include generating (850) a computer-readable comparison of the results of the parameter tuning operations for the hyperparameter sets, with the comparison indicating effectiveness of the hyperparameter sets, as compared to each other.

The performing (840) of the overall hyperparameter tuning operation can be done in a computer cluster, as discussed above. At least part of the hyperparameter tuning tool can be located outside the computer cluster. For example, a first part of the hyperparameter tuning tool can be located outside the computer cluster, and a second part of the hyperparameter tuning tool can be located inside the computer cluster. The technique can include, responsive to a request to start the overall hyperparameter tuning operation, sending a first set of one or more requests from the first part of the hyperparameter tuning tool to the second part of the hyperparameter tuning tool. Also, the technique can include, responsive to the first set of one or more requests, sending a second set of requests corresponding to the first set of one or more requests from the second part of the hyperparameter tuning tool to a machine learning framework running in the computer cluster, with the second set of one or more requests instructing the machine learning framework to perform the tuning jobs.

The technique of FIG. 8 can further include accessing the computer-readable comparison in computer memory, and presenting the computer-readable comparison via a user interface device. The technique can further include receiving a computer-readable selection of a selected hyperparameter set of the hyperparameter sets whose effectiveness is indicated in the comparison, and performing one or more subsequent parameter tuning operations on one or more parameter models using the selected hyperparameter set. For example, this performing of subsequent tuning operations may be done by submitting such tuning jobs to the parameter tuning application (250) of the parameter tuning system (240) discussed above with reference to FIG. 2.

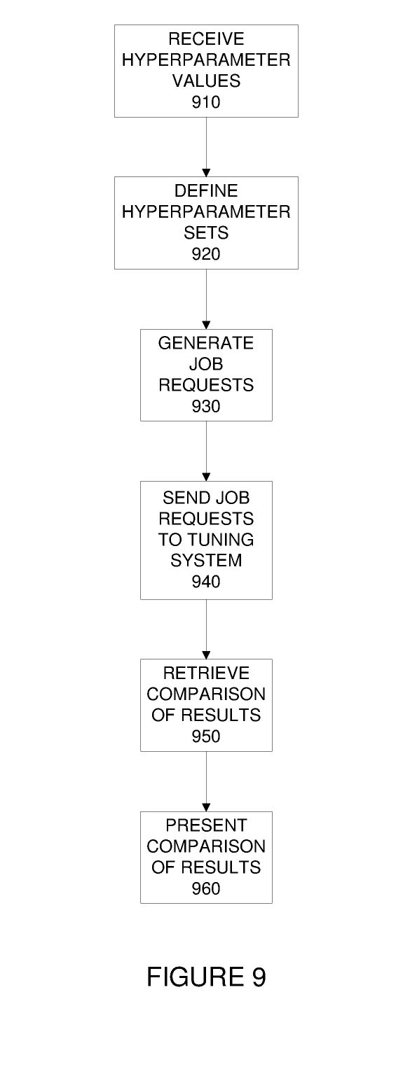

Referring now to FIG. 9, another hyperparameter tuning tool technique will be discussed. The acts of this technique can be performed via a hyperparameter tuning tool. The technique can include receiving (910) computer-readable values for each of one or more hyperparameters that govern operation of a computerized parameter tuning system in tuning parameters in a machine learning operation. For example, this may include receiving (910) these values as part of a request, such as a request to perform a hyperparameter tuning operation on the values. Receiving (910) the values may include receiving the values as user input hyperparameter values including multiple computer-readable values for each of multiple hyperparameters, with the user input hyperparameter values including a first set of multiple values entered in an entry area of a computer display corresponding to a displayed indication of a first hyperparameter of the multiple hyperparameters and a second set of multiple values entered in an entry area of the computer display corresponding to a displayed indication of a second hyperparameter of the multiple hyperparameters.

The technique can also include defining (920) multiple different computer-readable hyperparameter sets using the hyperparameter values, with each hyperparameter set including a different set of the hyperparameter values, and with each hyperparameter set including one of the hyperparameter values for each of the one or more hyperparameters. The defining (920) of the hyperparameter sets can include using the computer-readable values to generate different combinations of the computer-readable values.

The technique of FIG. 9 can also include generating (930) computer-readable tuning job requests using the hyperparameter sets, with the computer-readable tuning job requests each defining a different one of the hyperparameter sets to govern a parameter tuning job. Each tuning job request can be sent (940) to a to a computerized parameter tuning system, with each tuning job request instructing the parameter tuning system to conduct a parameter tuning job that includes tuning a parameter model as governed by a corresponding hyperparameter set defined in the tuning job request. The technique of FIG. 9 can also include retrieving (950) a comparison of results of the parameter tuning jobs, with the results indicating effectiveness of the different hyperparameter sets in tuning the parameter model. Further, the technique of FIG. 9 can include presenting (960) a representation of the comparison using a computer output device.

In the technique of FIG. 9, the parameter tuning system can include a computer cluster running a machine learning application. Also, the technique can further include sending to the machine learning application, requests corresponding to the tuning job requests.

Also, in the FIG. 9 technique, the one or more hyperparameter can include multiple hyperparameters, and the defining (920) of the hyperparameter sets can be performed in response to receiving user input, with the user input including a first set of multiple values entered on a computer display adjacent to an indication of a first hyperparameter of the multiple hyperparameters and a second set of multiple values entered on the computer display adjacent to an indication of a second hyperparameter of the multiple hyperparameters. The defining (920) of the hyperparameter sets can include identifying multiple different combinations of values from the first set of multiple values for the first hyperparameter and from the second set of multiple values for the second hyperparameter.

The defining (920) of the hyperparameter sets, the generating (930) of the tuning job requests, and/or the sending (940) of the tuning job requests to the parameter tuning system may all be performed in response to receiving a single computer-readable request, such as in response to receiving a single user input request.

The technique of FIG. 9 may further include selecting a computerized parameter tuning application from among multiple available different computerized parameter tuning applications with which the hyperparameter tuning tool is configured to operate, with the sending (940) of the tuning job requests to the parameter tuning system including instructing the parameter tuning system to use the selected parameter tuning application in conducting the parameter tuning jobs.

The technique of FIG. 9 can include monitoring progress of the parameter tuning jobs via the hyperparameter tuning tool. That monitoring can include receiving an indication of failure of a failed parameter tuning job of the parameter tuning jobs. Also, the technique can further include responding, via the hyperparameter tuning tool, to the indication of failure by re-sending to the parameter tuning system one of the tuning job requests corresponding to the failed parameter tuning job.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer system comprising:
at least one processor; and
memory comprising instructions stored thereon that when executed by at least one processor cause at least one processor to perform acts for hyperparameter tuning via a computerized hyperparameter tuning tool in the computer system, with the acts comprising:
receiving, via the hyperparameter tuning tool, multiple computer-readable values for each of one or more hyperparameters that govern operation of a computerized parameter tuning system in tuning parameters in a machine learning operation;
defining, via the hyperparameter tuning tool, multiple computer-readable hyperparameter sets that each includes a set of the computer-readable values, with the defining of the hyperparameter sets comprising using the computer-readable values to generate different combinations of the computer-readable values, and with each hyperparameter set comprising one of the computer-readable values for each of the one or more hyperparameters;
receiving, via the hyperparameter tuning tool, a computer-readable request to start an overall hyperparameter tuning operation;
in response to the request to start, performing the overall hyperparameter tuning operation via the hyperparameter tuning tool, with the overall hyperparameter tuning operation comprising a tuning job for each of the hyperparameter sets, with each of the tuning jobs comprising:
performing a parameter tuning operation on a set of parameters in a parameter model as governed by the hyperparameter set using the parameter tuning system, with the parameter tuning operation operating on computer-readable training data using the parameter model; and
generating computer-readable results of the parameter tuning operation for the hyperparameter set, with the results of the parameter tuning operation representing a level of effectiveness of the parameter tuning operation using the hyperparameter set; and
generating, via the hyperparameter tuning tool, a computer-readable comparison of the results of the parameter tuning operations for the hyperparameter sets, with the comparison indicating effectiveness of the hyperparameter sets, as compared to each other.

2. The computer system of claim 1, wherein the performing of the overall hyperparameter tuning operation is done in a computer cluster in the computer system.

3. The computer system of claim 2, wherein at least part of the hyperparameter tuning tool is located outside the computer cluster.

4. The computer system of claim 2, wherein a first part of the hyperparameter tuning tool is located outside the computer cluster and a second part of the hyperparameter tuning tool is located inside the computer cluster.

5. The computer system of claim 4, wherein performing the overall hyperparameter tuning operation via the hyperparameter tuning tool comprises:
responsive to a request to start the overall hyperparameter tuning operation, sending a first set of one or more requests from the first part of the hyperparameter tuning tool to the second part of the hyperparameter tuning tool; and
responsive to the first set of one or more requests, sending a second set of requests corresponding to the first set of one or more requests from the second part of the hyperparameter tuning tool to a machine learning framework running in the computer cluster, with the second set of one or more requests instructing the machine learning framework to perform the tuning jobs.

6. The computer system of claim 1, wherein the acts further comprise:
accessing, via the hyperparameter tuning tool, the computer-readable comparison in computer memory; and
presenting, via the hyperparameter tuning tool, the computer-readable comparison via a user interface device.

7. The computer system of claim 1, wherein the acts further comprise:
receiving a computer-readable selection of a selected hyperparameter set of the hyperparameter sets whose effectiveness is indicated in the comparison; and
performing one or more subsequent parameter tuning operations on one or more parameter models using the selected hyperparameter set.

8. A computer-implemented method of machine learning hyperparameter tuning, the method comprising:
receiving, via a computerized hyperparameter tuning tool, a request comprising multiple computer-readable values for each of one or more hyperparameters that govern operation of a computerized parameter tuning system in tuning parameters in a machine learning operation;
defining, via the hyperparameter tuning tool in response to the request, multiple different computer-readable hyperparameter sets, with the defining of the hyperparameter sets comprising using the computer-readable values to generate different combinations of the computer-readable values, and with each hyperparameter set comprising one of the computer-readable values for each of the one or more hyperparameters;
generating, via the hyperparameter tuning tool, computer-readable tuning job requests using the hyperparameter sets, with the computer-readable tuning job requests each defining a different one of the hyperparameter sets to govern a parameter tuning job;
sending, via the hyperparameter tuning tool, each of the tuning job requests to the parameter tuning system, with each of the tuning job requests instructing the parameter tuning system to conduct a parameter tuning job that comprises tuning a parameter model as governed by a corresponding hyperparameter set defined in the tuning job request;
retrieving, via the hyperparameter tuning tool, a comparison of results of the parameter tuning jobs, with the results indicating effectiveness of the different hyperparameter sets in tuning the parameter model; and
presenting, via the hyperparameter tuning tool, a representation of the comparison using a computer output device.

9. The method of claim 8, wherein the parameter tuning system comprises a computer cluster running a machine learning application, and wherein the method further comprises sending to the machine learning application, requests corresponding to the tuning job requests.

10. The method of claim 8, wherein the one or more hyperparameters comprises multiple hyperparameters, and wherein the defining of the hyperparameter sets is performed in response to receiving user input, with the user input defining the multiple values for each of the multiple hyperparameters, with the user input comprising a first set of multiple values entered on a computer display adjacent to an indication of a first hyperparameter of the multiple hyperparameters and a second set of multiple values entered on the computer display adjacent to an indication of a second hyperparameter of the multiple hyperparameters, and with the defining of the hyperparameter sets comprises identifying multiple different combinations of values from the first set of multiple values for the first hyperparameter and from the second set of multiple values for the second hyperparameter.

11. The method of claim 8, wherein the sending of the tuning job requests to the parameter tuning system is performed in response to receiving a single computer-readable request to start an overall hyperparameter tuning operation that includes the parameter tuning jobs.

12. The method of claim 8, wherein the request to start is responsive to a user input request.

13. The method of claim 8, wherein the generating of the tuning job requests is performed in response to receiving a single computer-readable request.

14. The method of claim 8, wherein the sending of the tuning job requests is performed in response to receiving a single computer-readable request.

15. The method of claim 8, wherein the defining of the hyperparameter sets is performed in response to receiving a single computer-readable request.

16. The method of claim 8, wherein the defining of the hyperparameter sets, the generating of the tuning job requests, and the sending of the tuning job requests to the parameter tuning system are all performed in response to receiving a single computer-readable request.

17. The method of claim 8, further comprising selecting, via the hyperparameter tuning tool, a computerized parameter tuning application from among multiple available different computerized parameter tuning applications with which the hyperparameter tuning tool is configured to operate, with the sending of the tuning job requests to the parameter tuning system comprising instructing the parameter tuning system to use the selected parameter tuning application in conducting the parameter tuning jobs.

18. The method of claim 8, further comprising monitoring progress of the parameter tuning jobs via the hyperparameter tuning tool.

19. The method of claim 18, wherein the monitoring comprises receiving an indication of failure of a failed parameter tuning job of the parameter tuning jobs, and wherein the method further comprises responding, via the hyperparameter tuning tool, to the indication of failure by re-sending to the parameter tuning system one of the tuning job requests corresponding to the failed parameter tuning job.

20. A computer system comprising:
at least one processor; and
memory comprising instructions stored thereon that when executed by at least one processor cause at least one processor to perform acts comprising:
receiving, via a hyperparameter tuning tool in the computer system, user input hyperparameter values comprising multiple computer-readable values for each of multiple hyperparameters, with the user input hyperparameter values comprising a first set of multiple values entered in an entry area of a computer display corresponding to a displayed indication of a first hyperparameter of the multiple hyperparameters and a second set of multiple values entered in an entry area of the computer display corresponding to a displayed indication of a second hyperparameter of the multiple hyperparameters;
in response to receiving a computer-readable request to define hyperparameter sets, defining via the hyperparameter tuning tool, multiple different computer-readable hyperparameter sets using the hyperparameter values, with each hyperparameter set including a different set of the hyperparameter values, and with each hyperparameter set comprising one of the hyperparameter values for each of the one or more hyperparameters;
generating, via the hyperparameter tuning tool, computer-readable tuning job requests, with each of the tuning job requests comprising a different one of the hyperparameter sets;
sending, via the hyperparameter tuning tool, each tuning job request of the tuning job requests to a computerized parameter tuning system, with each tuning job request instructing the parameter tuning system to conduct a parameter tuning job that comprises tuning a parameter model as governed by a corresponding hyperparameter set defined in the tuning job request;
retrieving, via the hyperparameter tuning tool, a comparison of results of the parameter tuning jobs, with the results indicating effectiveness of the different hyperparameter sets in tuning the parameter model; and
presenting, via the hyperparameter tuning tool, a representation of the comparison using a computer output device.
